(19) United States
(12) Patent Application Publication
(10) Pub. No.: US 2003/0125075 A1
(43) Pub. Date: Jul. 3, 2003

(54) Desktop stand and mobile phone

(76) Inventor: Flemming Klovborg, Copenhagen (DK)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/029,934

(22) Filed: Dec. 31, 2001

(51) Int. Cl. H04M 1/00

(52) U.S. Cl. 455/556; 455/573; 455/566

(57) ABSTRACT

The present invention relates to a desktop stand having a loudspeaker, a mobile phone with a build in radio tuner and/or music player and a system comprising both a mobile phone and a desktop stand. The system allows the use of the mobile phone together with the desktop stand as a clock radio.

It is suggested that FIG. 1 is published with the abstract.

The present invention relates to the field of mobile phones and mobile phone accessories such as desktop stands. In particular is relates to mobile phones having FM radio and/or music player functionality.

### BACKGROUND ART

Desktop chargers such as the Nokia® DCH-9 desktop stand serve conventionally two functions, namely, as a desktop stand and as a charger. The Nokia® DCH-9 desktop stand has further additional features for charging a spare battery. A Nokia® ACP-7 charger comprising an AC/DC transformer is connected to the Nokia® DCH-9 desktop stand and supplies the required DC current via a cable to the desktop stand. The Nokia® EDC-20 Desktop Charger/Speakerphone (U.S. Pat. No. 367,651) is a desktop stand for a mobile phone having charging capacity and in build speakerphone. The Nokia® 8310 and 6510, are advanced mobile phones which have an in-built FM radio. The Nokia® 5510 mobile phone comprises an FM stereo radio and a digital music player and recorder. From U.S. Pat. No. 366,873 and U.S. Pat. No. 380,753 there are known bases for cordless phones with a clock radio integrated in the base. As a general trend in the mobile phone industry an integration of a variety of functions is considered desirable. In most cases, the integration of additional functionality requires though extensive modifications to the existing hardware.

### DISCLOSURE OF THE INVENTION

On this background, it is an object of the present invention to provide a system comprising a desktop stand and a mobile phone of the kind referred to initially, with additional integrated functionality. This object is achieved in accordance with claim 1 by providing a system comprising a desktop stand and a mobile phone, said desktop stand comprising a loudspeaker and means to connect said loudspeaker to an audio signal from said mobile phone, said mobile phone comprises a radio receiver and/or audio signal player for producing said audio signal, said mobile phone further comprising means for routing said audio signal to said loudspeaker and a timer or clock to activate said radio receiver and/or audio signal player. This system allows the mobile phone together with the desktop stand/charger to be used as a clock radio.

Advantageously, said desktop stand is provided with a button for activating means for interrupting or ending said audio signal, and preferably said audio signal is interrupted for only a predetermined time, thus giving the system a so-called “snooze” functionality. Preferably, the amplitude of said audio signal is after activation gradually increased until a predetermined level, to avoid a brisk start of the audio signal.

The desktop stand may comprise a connector for conducting DC current to corresponding counterparts on said mobile phone for charging the battery of said mobile phone whilst it is placed on said desktop stand. Hereto, the desktop stand preferably may include a DC power source, in the form of an AC/DC converter and charging circuitry or has means to be connected to an external, preferably detachable, DC power source.

The desktop stand may comprise an amplifier, preferably associated with a volume button on said desktop stand, for amplifying said audio signal before routing it to said loudspeaker. In a preferred embodiment, the availability of a DC charging current allows the full screen size of a display on said mobile phone to be used to display the actual time when the mobile phone is placed on said desktop stand, with the screen back lights activated. Said desktop stand may further comprise a microphone and means for routing a signal from said microphone to said mobile phone, so that said system may be used as a speakerphone. Said desktop stand may further comprise a connector and said mobile phone a counterpart for transmitting said audio signal from said mobile phone to said desktop stand, or alternatively, the transmission of said audio signal could be by radio or infrared signal. Said mobile phone may comprise a menu controlled programmable alarm clock, allowing selection of the desired audio signal source.

It is another object of the present invention to provide a use of a mobile phone having a radio receiver and/or audio signal player for producing an audio signal and having a programmable alarm clock for activating said radio receiver and/or audio signal player together with a desktop stand having a loudspeaker as a clock radio.

It is another object of the present invention to provide a mobile phone of the kind referred to initially, with additional integrated functionality. This object is achieved in accordance with claim 13 by providing a mobile phone comprising a radio receiver and/or digital audio player for producing an audio signal, said mobile phone further comprising charging contacts arranged on an outer surface of said mobile phone for allowing contact with counterparts of a desktop stand or the like, said mobile phone further comprising contacts on said external surface of said mobile phone for allowing contact with counterparts arranged on said desktop stand or the like for routing said audio signal to said a desktop stand or the like.

A further object of the invention is to provide a desktop stand of the kind referred to initially, with an additional integrated functionality. This object is achieved in accordance with claim 17 by providing a desktop stand comprising a loudspeaker and a cradle for receiving a mobile phone, said cradle being provided with charging contacts for allowing contact with counterparts of said mobile phone and said cradle being provided with contacts for allowing contact with counterparts of said mobile phone receiving an audio signal from said mobile phone and routing said signal to said loudspeaker.

Further objects, features, advantages and properties of the system and use according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which:

FIG. 1 is a diagrammatic view of a desktop stand with a mobile phone placed on it,

FIG. 2a is a diagrammatic view from above of the desktop stand,

FIG. 2b is a diagrammatic detailed view from below on the desktop stand,

FIG. 3a is a diagrammatic frontal view on the mobile phone,

FIG. 3b is a diagrammatic view from below on the mobile phone, and

FIG. 4 is a diagrammatic view of a charger.

### DETAILED DESCRIPTION

In the following detailed description, the invention will be described by the preferred embodiments. With reference to the figures, the desktop stand 1 comprises a housing 10, having a flat base surface and four feet 5 for resting on a desktop surface (not shown) such as a writing desk or a night table. The desktop stand 1 has a connector recess 23 for charging a mobile phone 50, and respectively, a connector recess 24 for charging a spare battery (not shown) of the mobile phone 50. The combination of the desktop stand 1 and the mobile phone 50 will be referred to hereafter as “the system”. The connector recess 23 which is meant for the mobile phone 50 has a charging current connector 25, 25′ for feeding electric power and a connector 26, 26′ for an audio signal transfer between the mobile phone 50 and the desktop stand 1. The mobile phone 50 has a counterpart 56, 56′ for receiving charging current and connectors 57, 57′ for transferring the audio signal. Thus, when the mobile phone 50 is connected to the desktop stand 1, both audio signals and electric power can be transferred between them. The desktop stand is at its bottom surface provided with a loudspeaker 40. The loudspeaker 40 may be arranged in any other surface of the desktop stand to suit design and acoustic requirements as they may be.

The desktop stand comprises in a preferred embodiment an amplifier (not shown), for amplifying the audio signal from the mobile phone before routing it to the loudspeaker 40. A volume up/down button 32 associated with the amplifier is also provided on the desktop stand 1.

The desktop stand 1 is further provided with a slumber button 31 that activates a circuit located either in the desktop stand 1 or in the mobile phone 50 that interrupts the audio signal for only a predetermined time, thus giving the system a so-called “snooze” functionality. Further, a button 38 for terminating the audio signal is also provided on said desktop stand 1.

The desktop stand 1 is connected to an external charger 60, which converts AC power to DC power (for example, 6.5 V and 2A) and supplies a charging voltage to the connector 25, 25′ of the desktop stand 1. The charger 50, such as a Nokia® ACP-7 charger, is fully conventional, easily disconnectable from the desktop stand 1 through a connector on the charger cable (not shown) and a counterpart (not shown) on the desktop stand 1. The charger 60 can also be used to charge the mobile phone 50 in the absence of the desktop stand 1 by plugging the connector on the charger cable in the connector 55 of the mobile phone 50.

The desktop stand 1 comprises a connector 25, 25′ for conducting the DC current to corresponding counterparts 56, 56′ on the mobile phone 50 for charging the battery of the mobile phone 50 whilst it is placed on the desktop stand 1. A second charging connector 37, 37′ is provided on the connector recess 24 and is supplied with DC current from the same source for charging a spare battery (not shown).

According to another embodiment (not shown) the desktop stand 1 includes a DC power source, in the form of an AC/DC converter and means to be connected to the mains.

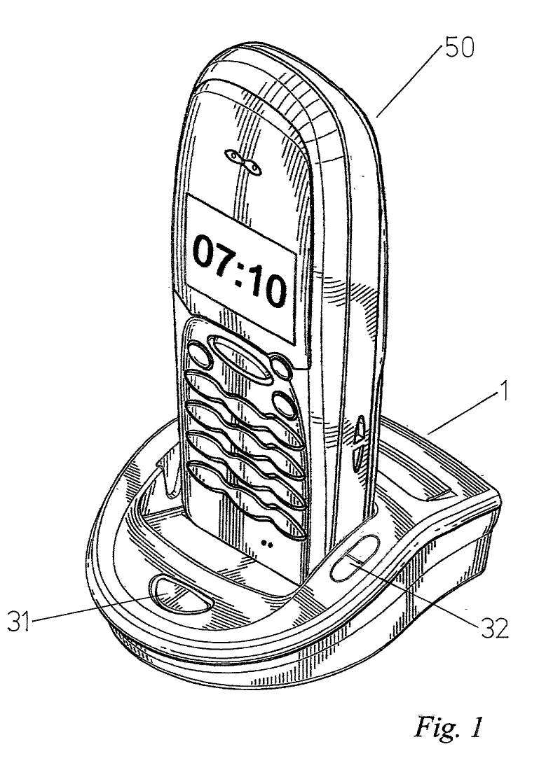

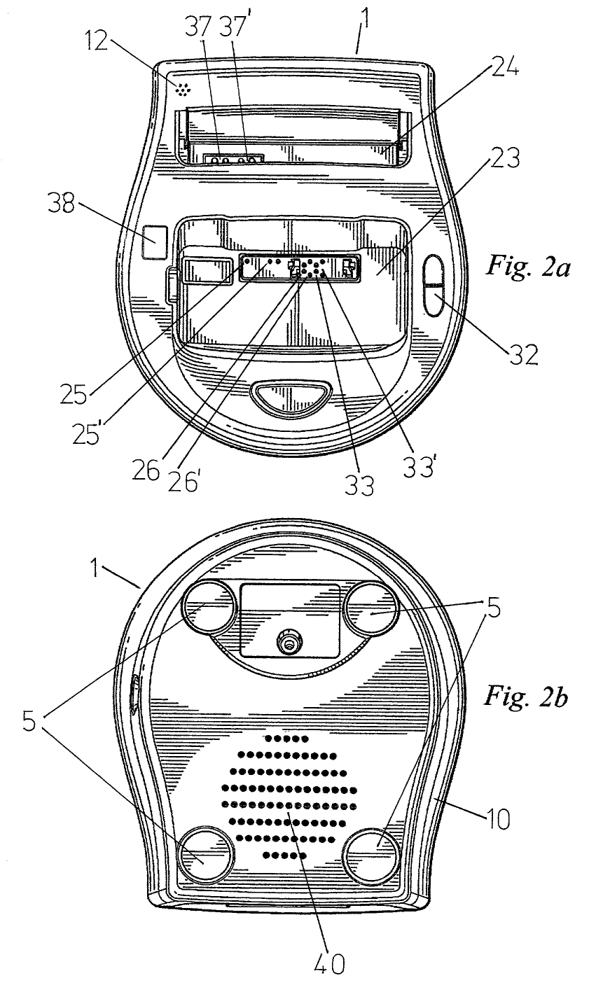

The desktop stand 1 is provided with microphone 12. As illustrated in FIG. 1, the microphone and an amplifier (not shown) may furnish audio signals to the mobile phone 50 during speakerphone operations through connectors 33, 33′ on the mobile phone 50 and connectors 77, 77′ in the cradle 24. However, the microphone 54 of the mobile phone 50 may be used instead if acoustic conditions so require. Gain may be added to the transmit path to facilitate the use of either microphone 12, 54. Audio signals during speakerphone operation from the mobile phone 50 may be furnished to the speaker amplifier in the desktop stand 1 and loudspeaker 40 in a similar manner. Speaker volume may be controlled from the desktop stand by adjusting the volume up/down button 32. In response, gain or loss will be added to the receive path. The loudspeaker 54 of the mobile phone 50 is not active during speakerphone operation.

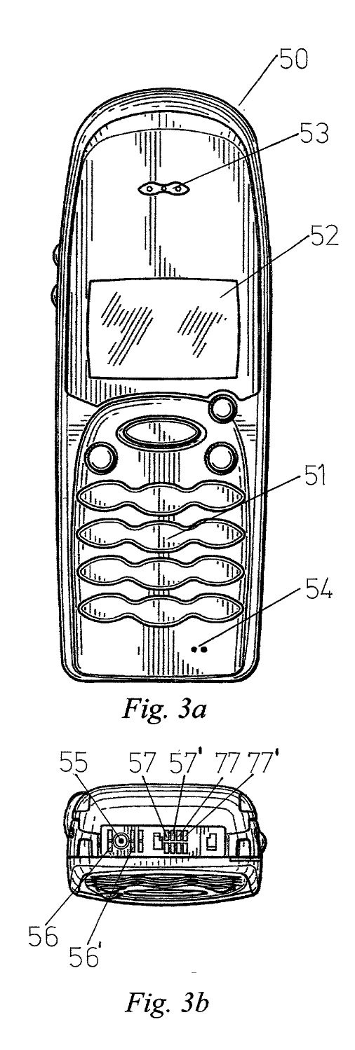

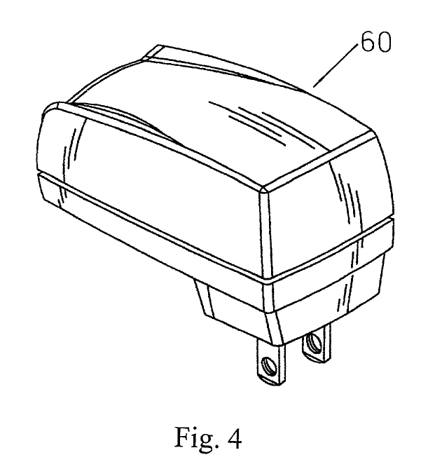

The mobile phone 50 as shown in more detail in FIG. 3 is provided at its front with an LCD display 52 and a keypad 51. Both the keypad 64 and the LCD display 52 are provided with a backlight to facilitate the use of the mobile phone 50 in low light conditions. The backlight switches off automatically shortly after the last use of the keypad 54 to reduce energy consumption, unless the mobile phone 50 is placed on the desktop stand 1 and receives DC power from a charger. Further, when the mobile phone 50 recognizes that it is placed on the desktop stand 1 and receives charging current, it will display the current time on the full screen size of the LCD display 52, with the screen back lights activated, so that it will serve as the equivalent to the digit-readings of a conventional clock radio.

The mobile phone 50, such as a GSM or 3G phones, is provided with an FM radio in the form of a tuner or a receiver. Alternatively, a radio tuner/receiver for a different radio frequency band such as AM may be used. In a preferred embodiment, the mobile phone 50 is provided with a digital music player, such as an MP3 or an AAC digital music player. Alternatively other types of music player may be used such as tape players or disc players etc. In another preferred embodiment, the mobile phone 50 is provided with both a FM radio receiver and a digital music player. The audio signal from any of the mentioned sources is routed to connector 57, 57′. The mobile phone 50 is menu controlled through the keys on the keypad 51. The menu allows section from a number of stored FM radio frequencies. The menu comprises a programmable alarm clock menu that allows selection of the desired alarm time, and selection of the desired source for the audio signal, e.g. the FM radio, the digital music player or one of a plurality of stored alarm signals. When the preset alarm time is reached, the mobile phone 50 activates the selected source for the audio signal.

Either the desktop stand 1 or the mobile phone 50 is provided with a circuit for gradually increasing the amplitude of the signal fed to the loudspeaker 40 after activation by the programmable alarm clock in the mobile phone 50, until a predetermined level is reached to avoid a brisk start of the audio signal when e.g. waking up a sleeping person.

According to a preferred embodiment, said desktop stand 1 comprises connectors 26, 26′, 33, 33′ and said mobile phone a counterparts 57, 57′, 77, 77′ for transmitting audio signals from the mobile phone 50 to the desktop stand 1 and vice versa. Alternatively, the transmission of said audio signals could be by radio signals such as in Blue Tooth Technology with the mobile phone 50 equipped with a short range radio transmitter and the desktop stand equipped with a radio receiver, or by infrared signals, with the mobile phone 50 equipped with an infrared transmitter and the desktop stand equipped with an infrared receiver.

1. System comprising a desktop stand and a mobile phone, said desktop stand comprising a loudspeaker and means to connect said loudspeaker to an audio signal from said mobile phone, said mobile phone comprises a radio receiver and/or digital audio player for producing said audio signal, said mobile phone further comprising means for routing said audio signal to said loudspeaker and a timer or clock to activate said radio receiver and/or audio signal player.

2. System according to claim 1, wherein said desktop stand is provided with a button for activating means for interrupting said audio signal, and/or a button for activating means for ending said audio signal.

3. System according claim 2, in which said audio signal is interrupted for only a predetermined time.

4. System according to any of claims 1 to 3, in which the amplitude of said audio signal is after activation gradually increased until a predetermined level.

5. System according to any of claims 1 to 4, in which said desktop stand comprises a connector for conducting DC current to corresponding counterparts on said mobile phone.

6. System according to any of claims 1 to 5, above in which said desktop stand includes a DC power source or has means to be connected to an external, preferably detachable DC power source.

7. System according to any of claims 1 to 6, in which the desktop stand comprises an amplifier, preferably associated with a volume button on said desktop stand, for amplifying said audio signal before routing it to said loudspeaker.

8. System according to any of claims 1 to 7, in which the full screen size of a display on said mobile phone is used to display the actual time when the mobile phone is placed on said desktop stand, preferably with the screen back lights activated.

9. System according to any of claims 1 to 8, in which said desktop stand further comprises a microphone and means for routing a signal from said microphone to said mobile phone, so that said system may be used as a speakerphone.

10. System according to any of claims 1 to 9, in which said desktop stand comprises a connector and said mobile phone a counterpart for transmitting said audio signal from said mobile phone to said desktop stand.

11. System according to any of claims 1 to 10, in which said mobile phone comprises a menu controlled programmable alarm clock, allowing selection of the desired audio signal source.

12. Use of a mobile phone having a radio receiver and/or digital audio player for producing an audio signal and having a programmable alarm clock for activating said radio receiver or audio signal player together with a desktop stand having a loudspeaker, as a clock radio.

13. Mobile phone comprising a radio receiver and/or digital audio player for producing an audio signal, said mobile phone further comprising charging contacts arranged on an outer surface of said mobile phone for allowing contact with counterparts of a desktop stand or the like, said mobile phone further comprising contacts on said external surface of said mobile phone for allowing contact with counterparts arranged on said desktop stand or the like for routing said audio signal to said desktop stand or the like.

14. Mobile phone according to claim 13, wherein said mobile phone further comprises a timer or clock to activate said radio receiver and/or audio signal player.

15. Mobile phone according to claim 13 or 14, in which the major part of a display on said mobile phone is used to display the current time when said charging contacts and said contacts for routing said audio signal to said a desktop stand or the like are in contact with their counterparts of a desktop stand or the like, preferably with the screen back lights activated.

16. Mobile phone according to any of claims 13 to 15, in which said mobile phone comprises a menu controlled programmable alarm clock, allowing selection of the desired audio signal source.

17. Desktop stand comprising a loudspeaker and a cradle for receiving a mobile phone, said cradle being provided with charging contacts for allowing contact with counterparts of said mobile phone and said cradle being provided with contacts for allowing contact with counterparts of said mobile phone receiving an audio signal from said mobile phone and routing said signal to said loudspeaker.

18. Desktop stand according to claim 17, wherein said desktop stand is provided with a button for activating means for interrupting said audio signal, and/or a button for activating means for ending said audio signal.

19. Desktop stand according to claim 17 or 18, further comprising a DC power source or further comprising means to be connected to an external, preferably detachable DC power source.

20. Desktop stand according any of claims 17 to 19, in which said audio signal is interrupted for only a predetermined time.

21. Desktop stand according to any of claims 17 to 20, further comprising an amplifier, preferably associated with a volume button on said desktop stand, for amplifying said audio signal before routing it to said loudspeaker.
